(19) United States
(12) Patent Application Publication
(10) Pub. No.: US 2005/0125547 A1
(43) Pub. Date: Jun. 9, 2005

(54) System for transferring information in a wireless data communication network

(76) Inventor: Petri Ahonen, Jyvaskyla (FI)

Correspondence Address: HARRINGTON & SMITH, LLP, 4 RESEARCH DRIVE, SHELTON, CT, 06484-6212, US

(21) Appl. No.: 10/497,834

(22) PCT Filed: Dec. 12, 2002
(86) PCT No.: PCT/FI02/01010

(30) Foreign Application Priority Data
Dec. 13, 2001 (FI) 20015050

(51) Int. Cl. G06F 15/16

(52) U.S. Cl. 709/228; 709/217

(57) ABSTRACT

The invention concerns a system for transferring information in a wireless data communication network using a chosen bearer between at least two parties of which one party is a party making service requests, who has a mobile station terminal known as such and equipped with at least a browser application, and the other party is a party responding to the service requests, who has a mobile station terminal which is equipped with a server environment and in connection with which the following are arranged an operation monitoring functionality including at least an access control partition and a possible database partition dB arranged in connection therewith, a server environment administration functionality, data transfer protocols, and information to be sent in response to the service requests. At least in connection with the said server environment a connection establishment and control functionality is arranged in order to arrange a connection through a chosen packet-switched information bearer.

The invention concerns a system for transferring information in a wireless data communication network using a chosen bearer between at least two parties, of which at least one party is one making service requests, who has a mobile station terminal known as such and equipped with a browser application and with possible connection settings arranged in connection therewith, and the other party is one responding to the service requests, who has a mobile station terminal equipped with a server environment, and arranged in connection therewith are
an operation monitoring functionality including at least an access control partition and a possible database partition dB arranged in connection therewith,
an administration functionality for the server environment,
data transfer protocols, and
information to be transmitted in response to the service requests
   and wherein in steps
the party making the service request with his terminal device in accordance with possible connection settings sets up a connection with the server environment of the party responding to the service request,
the server environment in a chosen manner identifies the party making the service request,
the party making the service request makes a service request with his terminal device,
the server environment interprets the service request, assembles a content corresponding to it and transmits it to the terminal device of the party making the service request, and
the party making the service request receives the information with his terminal device.

In mobile station terminal environments there are hardly any user-friendly and by simple way implemented methods for providing and storing, for example, public or personal information of the connection subscriber. Some very simple solutions are known for implementing functionality of this type, but they are difficult as such. The terminal device's SIM-card (Subscriber Identity Module) may be used for storing personal data, such as e.g. SMS (Short Message Service) messages received by the connection subscriber. The terminal device's memory may also be used for this purpose. The stored data may be processed by the terminal device's telephone memo, as an OTA (Over the Air) remote operation or by PC connection functions.

Such WAP (Wireless Application Protocol) services available to terminal devices suitable for the purpose represent a technique known before in the mobile station technology, which allow, for example, information retrieval from the Internet from an established address. Utilisation of WAP services, the number and application areas of which are constantly growing, takes place with a browser application according to the WAP standard and arranged in the terminal device.

WAP is an assembly of protocols, one purpose of which is to boost wireless communication. WAP is designed to take notice of various portable terminal devices, such as mobile stations, smart phones and PDA (Personal Digital Assistant) device as well as various bearers in the mobile network technology, such as SMS, USSD (Unstructured Supplementary Services Data), CSD (Circuit Switched Data) and packet-switched bearers, such as e.g. GPRS (General Packet Radio Service) etc.

In the known WAP technology the user of a mobile station terminal device uses the WAP browser of his terminal device to transmit to an address, which he has defined in the connection settings, a service request, which is relayed through the mobile network to a possible WAP gateway. The WAP gateway shapes the service request from the form understood by the wireless data communication network, for example, into a shape understood by a WWW server located on the Internet and relays it further to the WWW server of the party corresponding to the object of the request. Known Internet protocols are used between the WAP gateway and the WWW server. Solutions not having any WAP gateways may be implemented e.g. with a WAP application server, from which information can be downloaded directly by the user terminal device's WAP browser over the data communication network.

However, WAP servers are implemented as quite huge and centralized solutions, whereby they are chiefly intended for commercial use, such as e.g. for trading in merchandises and services, for providing news and weather forecast services etc.

Private users of mobile stations also have the possibility to provide public information about themselves, for example, through their own WAP home pages. These may be arranged e.g. at a WWW server maintained by the user's ISP (Internet Service Provider), which can then be browsed by WAP terminal device users, for example, with the terminal device's WAP browser. Even then browsing of pages takes place in the manner described above by way of a possible WAP gateway. However, even then the system is strongly centralized at the server, whereby for the client offering information its updating ability is difficult and it is also disadvantageous from the browser's point of view due, among other things, to resulting connection costs. In addition, providing public information requires expert knowledge to do with, for example, the working out of WAP pages.

Besides these ways of providing, which are presented above, special server functionalities have also been developed, which are arranged in wireless terminal devices. WO publication 01/84871 presents a solution, wherein a predetermined subscriber identity is joined to the user's personal WEB page. In this case only personal user information is provided using the server. The technical features of the implementation make it possible to make service requests to one terminal device only at a time, or in a case with several connection parties it would at least be essentially difficult to arrange. In this case, too, unsolved drawbacks remain as regards reliability and data security (authentication). On the other hand, such a system based on a circuit-switched implementation is also strongly dependent on the existing mobile station infrastructure.

Publication EP-0 918 423 A2 also presents a WEB server arranged in a mobile station terminal. In this case also the operation of the server is bound up with the mobile station infrastructure. A connection can be set up with the server through the air interface, for example, from a central machine arranged on the Internet (for example, the server of a medical service or a motor car repair shop), but not e.g. from another terminal device communicating in the mobile network. Due to the nature of this information relayed through a data communication network (for example, information on the state of health, the data size of which is known to be rather small) significant costs will arise, because a connection must be set up between the devices for each data transfer session. Furthermore, the server does not allow, at least not very easily, simultaneous connection for several parties with the different applications of the server, because it would be very difficult or even impossible to secure the difference of connections. In the case of both publications this concerns, for example, the performance of P2P applications.

The purpose of the present invention is to bring about an essentially simpler, more advantageous and more private system for transferring information in a wireless data communication network. The characteristic features of the system according to the invention are presented in claim 1.

The system according to the invention is implemented in such a way that into a mobile station terminal is fitted a server environment, with which the other mobile station users can be in connection with their applicable terminal devices through a wireless packet-switched data communication network.

According to a more advanced embodiment, with short distances wireless local area network technology may be utilised as the bearer, such as e.g. a Bluetooth or WLAN (Wireless Local Area Network) connection. Transfer of the information from the server to the terminal device and vice versa can hereby be implemented even entirely independently of the mobile network. According to one embodiment, the terminal devices may hereby organize themselves, for example, as a non-structured ad hoc network.

Quite a new manner is achieved with the system according to the invention in communication between terminal devices. Besides the data transfer taking place from the terminal device towards the network, also the opposite party may now transfer data through the network to the server terminal device.

Furthermore, according to an advantageous embodiment, when the terminal device is out of reach, the connection can be diverted elsewhere. Hereby the calling party is offered much more many-sided possibilities than before of e.g. leaving a message or a call back request to the called party. In this embodiment, the content arranged for provision to the server terminal device is also provided elsewhere. In addition, it is also possible to arrange efficient searching services in connection with the system, whereby searching operations may be carried out in the contents released by the terminal devices.

Additional advantages achieved with the system include a decentralized server functionality and in consequence easy updating of the contents and independence of the state-of-the-art central-server-based system and also generally of the mobile station infrastructure, which can be achieved by networking of terminal devices, for example, networking of the ad hoc type. Other additional advantages achieved with the system according to the invention emerge from the description part while the characteristic features emerge from the appended claims.

The system according to the invention, which is not limited to the embodiments to be presented hereinafter, is described in greater detail by referring to the appended figures, wherein

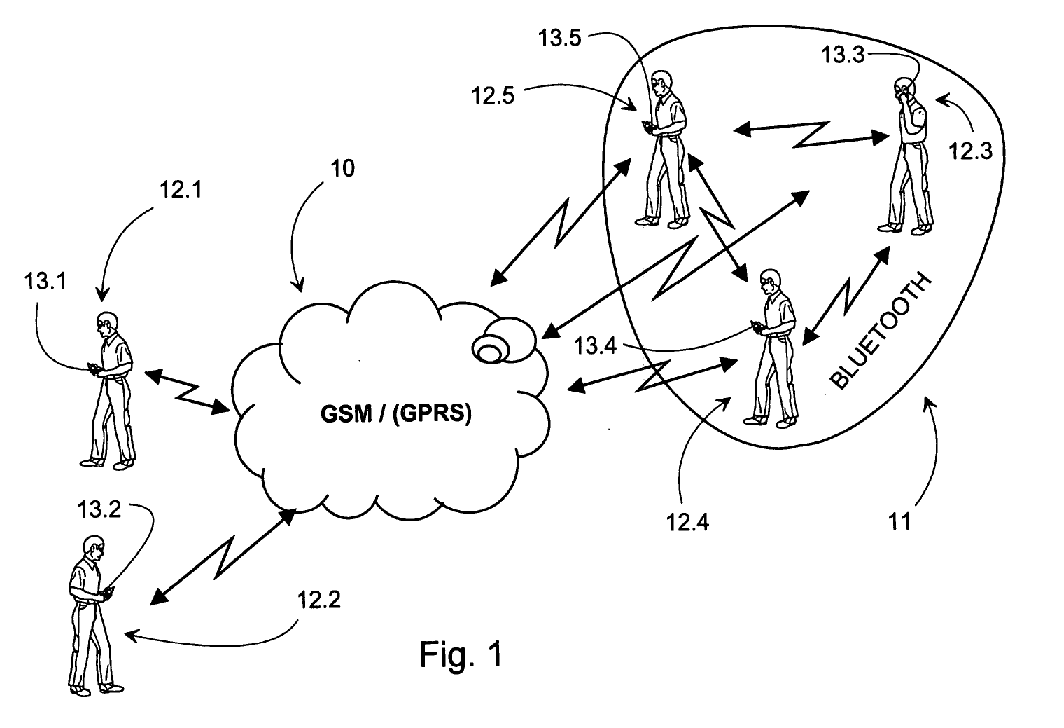

FIG. 1 shows an application example of the system according to the invention,

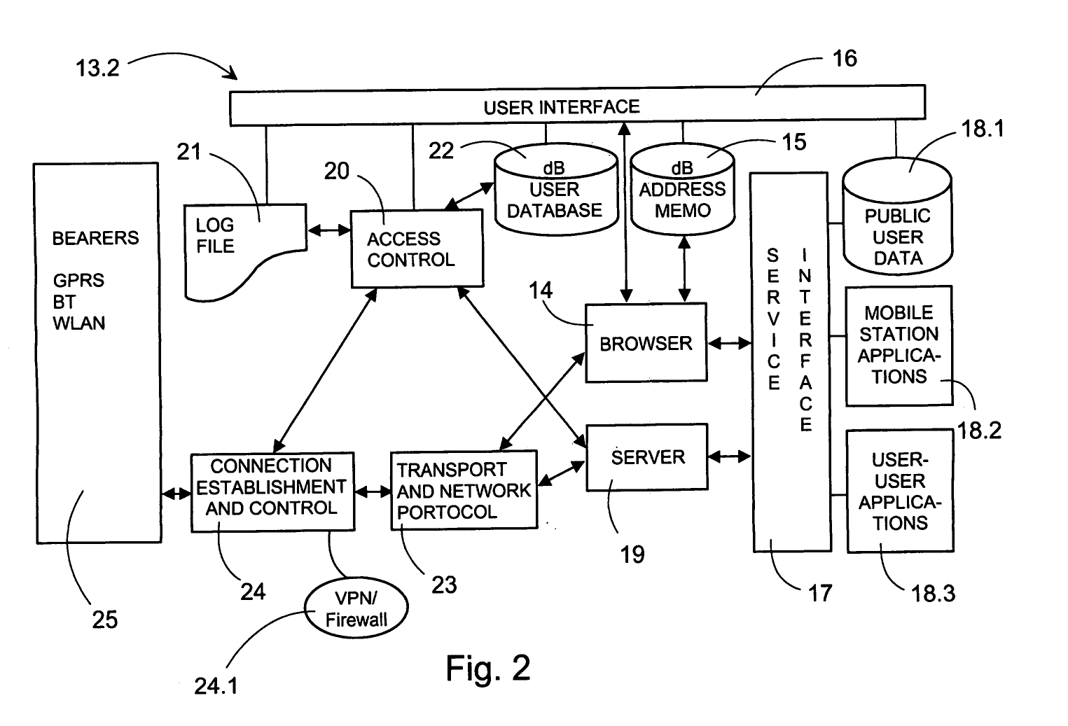

FIG. 2 is a rough schematic view of the logical components of a terminal device implementing the system according to the invention,

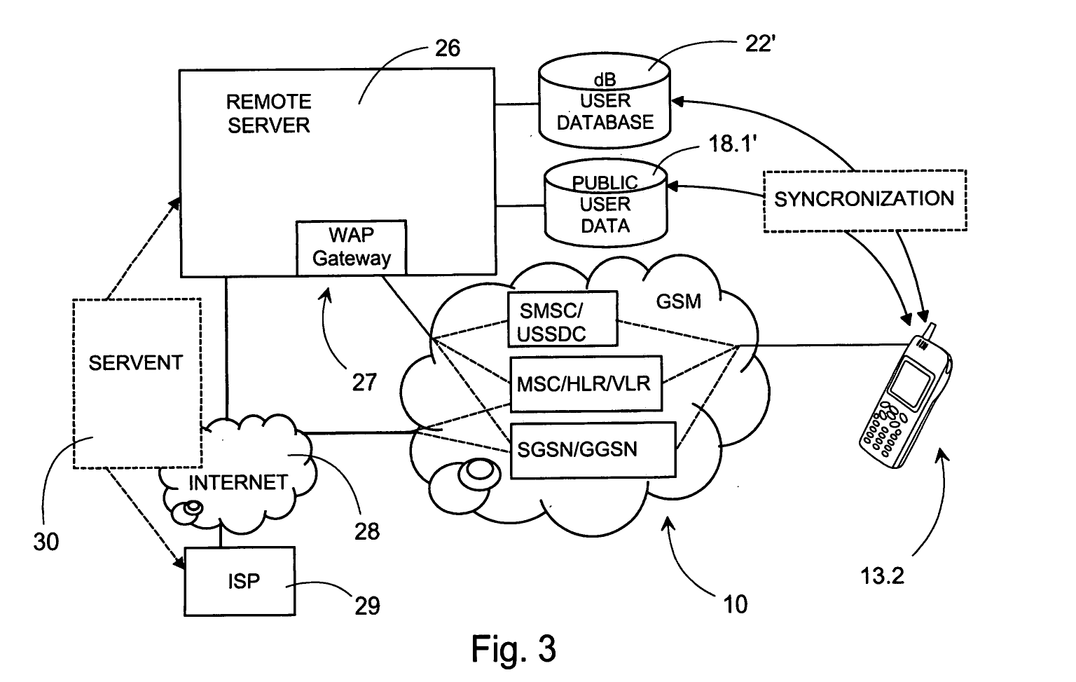

FIG. 3 is a rough schematic view of provision of information when the server environment according to the invention is out of reach, and

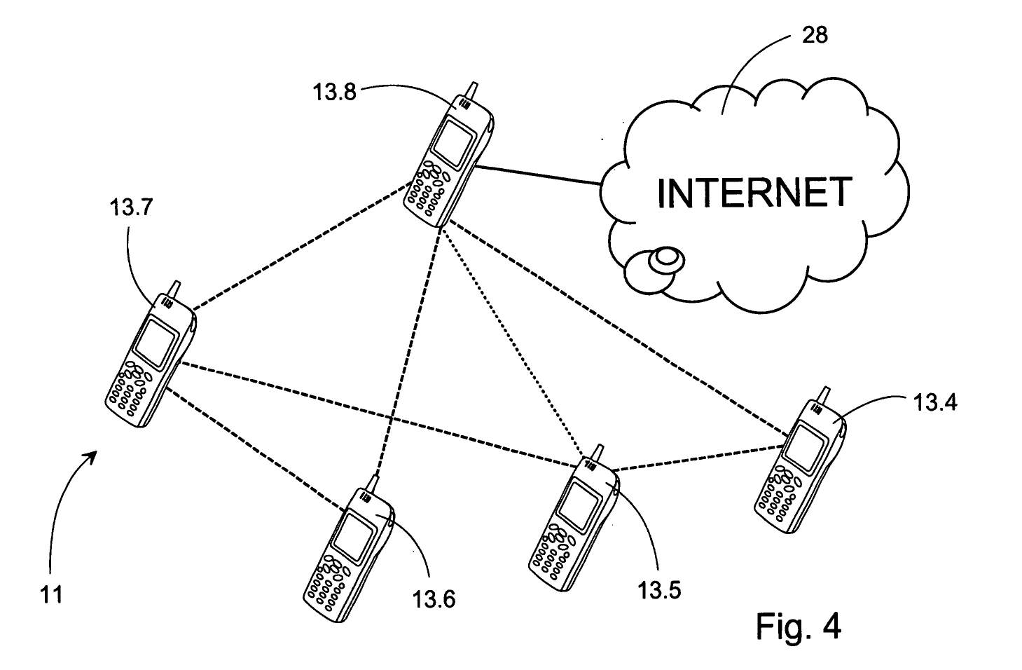

FIG. 4 shows an example of an ad hoc implementation of the system according to the invention.

FIG. 1 shows an application example of how the system according to the invention is used in a wireless data communication network 10. The users 12.1-12.5 have terminal devices 13.1-13.5 supporting, for example, the WAP standard. The terminal devices 13.1-13.5, which may be mobile stations according to the example, PDA terminal devices or “smart phones” of a corresponding kind, may be within the sphere of influence of a mobile network, such as e.g. a GSM network 10. Hereby they can be used for communicating by way of packet-switched bearers known as such. GPRS (General Packet Radio Services) and CDMA2000 1× represent examples of such bearers. Other All-IP implementations now being developed are also possible (3G).

In the system according to the invention, the mobile station terminals 13.1-13.5 may also be equipped with a local area network communication feature, such as, for example, a Bluetooth connection 11. Hereby the users 12.1-12.5 need not necessarily be located within the coverage area of the mobile network 10. The coverage area of the Bluetooth connection 11 is the nearby sphere of terminal devices 13.1-13.5, which nowadays is approximately 10 metres. Another example of a bearer allowing communication from a close distance is WLAN, which can be used to achieve a field strength of 100 metres nowadays.

FIG. 2 is a schematic view of an embodiment showing the logical components of a mobile station terminal 13.2 implementing the system according to the invention and also showing their mutual linking relationships. Essential in the system according to the invention is to locate the server environment embedded into the mobile station terminal 13.2. In the example, the server environment to be run by the terminal device 13.2 is formed in accordance with the WAP protocol, which is a content provision standard designed for wireless mobile devices. Already existing content provision methods or those under development are of course also possible.

The terminal device 13.2 functioning as a WAP server includes a user interface UI 16, through which the users 12.1, 12.3-12.5 may make service requests concerning contents and functionality arranged for the terminal device 13.2. In connection with the user interface 16 there is also a WAP browser application 14 embedded into the server terminal device 13.2, for example, a WAP or WEB browser (Embedded Client). The browser application 14 may also be, for example, text-based depending on the session layer determining the data transfer format to be used. Also JAVA application or message router implementations, such as e.g. ORB (Object Request Broker), may be possible browser embodiments (not shown).

In connection with the WAP browser application 14 there is, for example, an address memo dB 15 of the server terminal device's 13.2 subscriber 12.2, wherein favourite links of the server terminal device's 13.2 user 12.2 are stored as well as any related connection settings. Furthermore, in connection with the browser application 14 there are the terminal device's 13.2 transport and network protocol modules 23 and in connection with these there are connection control and establishment modules 24, which are used for carrying out the data transfer routines to the available packet-switched bearers 25.

To establish a connection 24 a protocol is used, which allows identification of the handshaking party. The PPP (Point-to-Point Protocol) may be mentioned as an example of such a protocol. In connection with PPP e.g. the PAP (Password Authentication Protocol) based on the user identity and password or the CHAP (Challenge Handshake Authentication Protocol) may be used as a method of authentication, depending on the bearer 25 to be used. With support from these authentication protocols the server terminal device 13.2 can be safely connected to all standard-based networks, whereby the performance power still remains at an optimum. After the authentication, a connection is establish and it is controlled e.g. on the socket interface of the connection.

In the connecting and control partition 24 it is possible to implement a combined VPN/firewall functionality 24.1 according to an advantageous embodiment of the invention. With such a functionality, which is essentially separate from the actual embedded server application 19, especially secured conditions are brought about for data communication between terminal devices, whereby several terminal devices 13.1, 13.3-13.5 may be simultaneously connected to different services 18.1-18.3 of the terminal device 13.2 functioning as server within the resources provided by the server 13.2.

Transport and network protocols 23 attend to the data transfer and transmission. These are, for example, Internet protocols known as such, such as TCP/IP (Transmission Control Protocol/Internet Protocol) and UDP/IP (User Datagram Protocol/Internet Protocol) or possibly the WAP protocol, such as WTP (WAP Transaction Protocol) and WDP (WAP Datagram Protocol). In principle, the IP addresses are of no significance to the addressing of service requests between the terminal devices 13.1-13.5. Hereby when a terminal device is in connection with another terminal device, it does not matter what IP number is used, as long as some is used (for example, a default/temporary IP address). On the other hand, when an IP address is used for routing a call e.g. in an ad hoc network, it must be bound up with the terminal device 13.1-13.5.

The terminal device's 13.2 server and administration functionality is implemented by using it to run an embedded server 19. To this are also linked a service interface 17, access control 20 and the connection control/establishment functionality 24 and transport/network protocols 23 already mentioned in connection with the browser application 14.

Linked to the access control 20 is also a possible log file 21, wherein events of the server terminal device 13.2 are entered, such as, for example, connection establishments, received service requests and data transfers made to the server terminal device 13.2. The access control 20 also has a database dB 22 containing e.g. parties entitled to establish a connection with server 13.2, data needed for their authentication, and also their addresses and connection parameters. Provided services may also be limited on a connection and user basis, depending on whether sufficient free resources are available in the terminal device 13.2 running the server application 19.

The access control 20 is used to administer, for example, rights, such as who in general has the right to be in connection with the server, what type of content each party 12.1, 12.3-12.5 connected with server 13.2 is accessed to download and who, for example, has the right to transmit data to the server 13.2, since a part of the connection costs may hereby have to be paid by the server's 13.2 subscriber 12.2.

Embedded browser and server applications 14, 19 are arranged in connection with a service interface 17. The server application 19 replies to the service requests sent to it, which may arrive at the terminal device 13.2 in different formats. Server application 19 collects a content corresponding to the service requests through service interface 17 and transmits as a reply to the calling terminal device a content or functionality corresponding to the service request.

As content to be provided e.g. data 18.1 intended by user 12.2 as public data (visiting card with contact information) is arranged behind the service interface 17. Furthermore, there may also be such applications behind interface 17, which may be remote-started with their own terminal devices 13.1, 13.3-13.5 by other parties 12.1, 12.3-12.5 connected to server 13.2. Examples of such mobile station applications 18.2 are flashing of the terminal device's 13.2 backlights or output of an image on the display. In addition, there may be P2P applications 18.3 (peer-to-peer computing) behind interface 17, such as a chat connection that can be activated between users. Explicitly from point of implementation of these P2P applications the functionality provided by the connection establishment and control modules 24 allows functioning of the system especially in packet-switched data communication networks 10, 11.

Public user information 18.1 may also be arranged directly in connection with the user interface 16, so it may also be browsed by “outsiders” without any access control routines 20.

When using markup language-based browser applications, the service interface 17 may be controlled by using, for example, scripts, JAVA or URL-controlled files and service starts. Also formal command strings may be served, in case the server terminal device 13.2 is implemented in such a way that it will identify a certain command series. Also remote calls according to the CORBA architecture (Common Object Request Broker Architecture) may be utilised, whereby the ORB core (Object Request Broker) relays the call into a command that can be interpreted.

FIG. 3 shows an advantageous embodiment in a situation, where for some reason the calling party's 12.1 attempt to establish a connection does not succeed in the called party's 12.2 terminal device 13.2. Such a situation can occur, for example, in such cases where the called party's 12.2 terminal device 13.2 is turned entirely off or the resources it provides are all loaded.

According to an advantageous application example of the invention, in such a situation the MSC (Mobile Services Switching Centre) of the data network, such as the GSM network 10 in the case according to the example, detects that the server terminal device 13.2 is out of reach or busy. The switching centre will activate a divert service of a kind known as such, by which the attempt at connection establishment is diverted, for example, to a remote server 26 maintained by an Internet operator, that is, ISP (Internet Service Provider). If the attempt to establish a connection to the server terminal device 13.2 takes place with a terminal device 13.1 equipped with a WAP browser application 14, the divert service is implemented to the ISP. For example, the called party's 12.2 WAP home page is hereby downloaded from the ISP's remote server 26 in the WAP browser of the calling party's 12.1 terminal device 13.1. Correspondingly, if the calling party 12.1 tries to send messages/packets to a server terminal device 13.2, which is not available to receive them, they can also in a similar manner be diverted to the ISP's remote server 26, and then e.g. in connection with the next synchronization they will be transferred to the server terminal device 13.2 (correspondingly as e.g. in the SMS service).

Arranged in the remote server 26 are hereby at least the server terminal device's 13.2 subscriber-holder's 12.2 user database dB 22′ and the user data 18.1′ established for public provision. These are synchronized from the server terminal device 13.2 to the remote server 26 e.g. at established intervals or according to some other established criterion.

Furthermore, the functionality arranged in remote server 13.2 includes, among other things, access control and a synchronization function for the databases of the said server terminal device 13.2 as well as a linking function for the ISDN number and the IP address. Hereby the ISP may function e.g. as a VOIP (Voice over IP) gateway, whereby a call relayed through the Internet 28 arrives at the remote server 26 and the user 12.2 of terminal device 13.2 is in connection with data network 10.

Furthermore, ISP may also provide various searching and networking services, which function on the P2P principle. In order to bring about such services, a determined interface must be arranged between several ISPs 26, 29. The services can be advantageously implemented e.g. by server agents, that is, by servents 30, which synchronize that content/application index information of the different ISPs 26, 29 or server terminal devices 13.1-13.5, for which the actual local searching is carried out. Hereby the ISPs function as a mutually unstructured ad hoc network moving index information between them. If many WAP pages are stored in the remote server 26 arranged in connection with the ISP, it is possible on their pages in WML (Wireless Markup Language) to arrange searching services in a manner similar as such to e.g. the HTML (Hypertext Markup Language) technique, mentioning a searching service from user information as an example.

FIG. 4 shows an example of the system according to the invention as an ad hoc implementation using wireless local area network technology, such as packet-switched Bluetooth 11 or WLAN (Wireless Local Area Network). The wireless ad hoc implementation is unstructured and therein the wireless terminal devices 13.4-13.8 discuss with one another without any fixed physical network architecture. In the ad hoc implementation 11 each terminal device 13.4-13.8 is obliged when required to relay each other's traffic, which is arranged in the connection establishment and control partition 24 of the terminal devices 13.4-13.8. The terminal device 13.5 becomes a router, for example, in a situation where two terminal devices 13.4, 13.7 located outside each other's range wish to discuss with one another. Hereby those terminal devices, which are located in between these two, have to relay the traffic between them. Thus, in this case the route from one terminal device to the other may include several links, differently from cellular networks, wherein the base transceiver station always has a direct link with the moving terminal device.

Here the terminal device 13.7 is in connection with the terminal devices 13.5, 13.6 and access point 13.8 located within its coverage area, through which there is a connection e.g. with the Internet 28. The terminal device 13.7 scans and listens actively to its neighbour terminal devices 13.5, 13.6. If an IP address transmitted to the network 11 is compatible with a neighbour terminal device 13.5, 13.6, it will be relayed directly to the terminal device corresponding with the IP address and not to the access point 13.8 or the Internet 28.

In accordance with the foregoing, the terminal devices include, besides the server functionality 19, especially in the case of wireless location area networks 11, also a functionality of the gateway type, which may also be implemented e.g. in the connection establishment and control module 24.

The searching operation and linking of networks to each other without any state-of-the-art access point 13.8 may according to one embodiment also be solved in such a way that active server agents or servents are used in the distribution of service requests. One example of such an implementation are the files exchange networks of the Gnutella type based on peer-to-peer network implementation, that is, a certain type of searching service organisations. Such a manner of implementation of the Gnutella type allows distribution of files between terminal devices without any actual central unit.

Thus, this embodiment does not present or specify in any way “the origin of networking”, as happens in server-oriented implementations, but it is up to each party in the network to make the required definitions. The implementation is also characterized by that it does not in any way specify from which part of the network the service requests are being sent. In this embodiment this happens in a simple manner, since the service request is sent to the terminal devices located within the coverage area listening to each other.

Besides the specification of distribution in the files system, it is preferably possible in the system according to the invention also to distribute other applications and generally functionality arranged for the server terminal device, so this being the case the term “content” can in fact be understood very broadly. This is made possible by the fact that the mobile station terminal's embedded server is not arranged only for remote use of the server functionality, but also, for example, for interpretation of the WML markup language and as a service interface for mobile applications.

In the case of GPRS and WLAN bearers, a way of implementation ay be a service provider (server) arranged in a data communication network 10, 11, through which data transfer takes place between terminal devices. In the case of WLAN, this is exactly the “access point” described above, and in the case of GPRS, for example, a server arranged in a mobile services switching centre.

In the following the operation of the system according to the invention will be described as an application example, wherein two terminal devices communicate with each other through a wireless location area network connection, such as Bluetooth 11 and a data network, such as the GSM network 10, allowing packet data communication with a GPRS bearer.

The right side half of FIG. 1 shows the establishment of a connection between terminal devices using a Bluetooth connection. Hereby the user 12.4 of a terminal device equipped with a WAP browser and a BT connection feature may be interested in knowing whether within the coverage area of his terminal device 13.4 there are other such terminal devices equipped with the Bluetooth feature, wherein that described WAP server environment is possibly run, which is fitted into the terminal device. This matter is examined in such a way that user 12.4 switches on the terminal device scanning in his terminal device 13.4, whereby this will possibly find another such terminal device 13.5 equipped with the BT feature, with which user 12.4 may try to connect, if the said server environment be found therein.

When establishing of a connection is attempted the access control 20 of the called server terminal device 13.5 is activated asking e.g. for the logining user's 12.4 Bluetooth authentication or PIN code or for his RAS (Remote Access Server) password, which is used in the choice of privacy level for the terminal device's 13.5 data. Using the RAS password acceptance can be arranged of the called party 13.5 to participate in a part of the resulting costs of communication. Having entered the correct PIN code, the calling party 12.4 may move over to its possible private storing area granted to it by the owner 12.5 of the server terminal device 13.5.

In case the PIN code stated by the user is wrong, his connection will be diverted, for example, to the server terminal device's 13.5 public storing area. The data can be browsed through and used in the storing area by the terminal device's 13.4 WAP browser, whereby it is in the WML format. The server terminal device's 13.5 user interface is designed and created e.g. by the terminal device's 13.5 owner 12.5, for which purpose the terminal device 13.5 preferably also includes an application packet for creating about the contents to be provided (not shown). This may include ready-made content bases, page models and also a WML generator assisting in creating about the contents.

The objects browsed may be, for example, the owner's 12.5 home pages, favourite links. Furthermore, the terminal device 13.5 may include ready-made CGI scripts, which require releasing of the API (Application Programming Interface) providing services for the application. Furthermore, more advanced services may be available to the server terminal device 13.5, such as chat, a notice board, downloading of files. The data storing area may also be used as a user interface of its own, for example, as a file manager implemented by a Java middlet.

Correspondingly, when using the GSM/GPRS method of connection establishment, such as e.g. in the left side half of FIG. 1, the connection is started by a call made by the calling party 12.1. This may be a so-called WAP call, whereby the terminal device 13.1 will start the browser application 14 for user 12.1. The password is asked for, and then the available function alternatives are shown on the terminal device's 13.1 display. These may be, for example, “Connect sound call to NN”, “Look at my home pages”, “Reserve a time for meeting in my calendar” etc. The WML page to be downloaded first on the calling party's WAP browser depends on the privacy level granted to him or on the password given by him, whether it was correct or wrong. Then the same services will be available as in the BT connection described above. A normal phone call may also be converted automatically into a WAP call, in case the called party owning the server feature in his terminal device should happen to be busy or in another such situation.

Thus, the functionality arranged in the calling party's 12.1 terminal device 13.1 includes, besides the mere browser functionality 14 of a kind known as such, also a kind of functionality of the “client” type, whereby it also attends to establishment of a communication session, to use of the services provided in the terminal devices and at the same time also to releasing of services of its own terminal device 13.1. This functionality is of a special significance explicitly in the case of wireless local area network architectures, because maintenance of connections is hereby totally dependent on the terminal devices forming the location area network. This functionality can be understood as a service provider of a certain kind, which allows access to the data communication network 10, 11 formed by the terminal devices.

The owner 12.1 of the server terminal device may need to be notified when the other party 12.2 performs downloading of data. This could e.g. be indicated by an icon on the server terminal device's 13.1 display. The party 12.1 owning the data also has the possibility to cut off the connection of this party 12.2 connected to his terminal device server 13.1, should he like to do so. This is especially true in a case where the owner 12.1 of the server terminal device 13.1 must share the costs of the connection.

With the system according to the invention an essentially reliable and secured data transfer is achieved between a server arranged in a terminal device and such one or more terminal devices connected to it, which include the needed functionalities. Using connection control and establishment components 24 arranged essentially separate from the server 19 a functionality of the gateway and VPN/firewall type is brought about, which has an essentially significant part in packet-switched data transfer and in wireless location area networks for establishing and maintaining reliable connections.

It should be understood that the above description and the figures relating to it are only intended to illustrate the system according to the present invention. Thus, the invention is not limited only to the embodiments presented above or to those defined in the claims, but many such kinds of variations and modifications of the invention will be obvious to the man skilled in the art, which are possible within the scope of the inventive idea defined by the appended claims.

1. System for transferring information in a wireless data communication network using a chosen bearer between at least two parties of which one party makes service requests and has a mobile station terminal known as such and equipped with at least a browser application and with a possible connection setting arranged in connection therewith, while the other party responds to the service requests and has a mobile station terminal, which is equipped with a server environment and in connection with which the following are arranged
an operation-monitoring functionality including at least an access control partition and a possible database partition dB arranged in connection therewith,
a server environment administration functionality,
data transfer protocols, and
information to be sent in response to the service requests and wherein in steps
the party making the service request with his terminal device in accordance with possible connection settings sets up a connection with the server environment of the party responding to the service request,
the server environment identifies in a chosen manner the party making the service request,
the party making the service request uses his terminal device to make a service request,
the server environment interprets the service request, puts together a corresponding content and sends it to the terminal device of the party making the service request, and
the party making the service request receives the information with his terminal device,
characterized in that in connection with each of the terminal device is fitted a browser application and a server environment for making the service requests and for dealing with them and in connection with the terminal devices a connection establishment and control functionality is arranged to arrange a connection through the chosen packet-switched information bearer and in which at least part of the terminal devices include a gateway implementation in order to relay data transfer between the terminal devices (13.1-13.8) which may together constitute one or more subnetworks.

2. System according to claim 1, characterized in that the server environment is in accordance with the WAP standard.

3. System according to claim 1, characterized in that the data transfer network is a mobile network, wherein the bearer is, for example, a GPRS (General Packet Radio Service) connection.

4. System according to claim 1, characterized in that the data transfer network is a wireless local area network, such as for example one based on Bluetooth or WLAN (Wireless Local Area Network) technologies.

5. System according to claim 4, characterized in that the data transfer network is at least partly unstructured, such as for example an ad hoc network.

6. System according to any one of claim 1, characterized in that the said connection control and establishment functionalities include a gateway implementation as one sub-functionality.

7. System according to any one of claim 1, characterized in that the data link layer protocol (for example, PPP (Point-to-Point Protocol)) for use in establishing the connection allows identification of the party making the service request.

8. System according to claim 7, characterized in that an Internet or WAP protocol is used as the transport and network protocol.

9. System according to claim 1, characterized in that for identification e.g. the authentication code or PIN code of the Bluetooth technology is used or a RAS (Remote Access Server) password is used.

10. System according to claim 9, characterized in that identification is used to accept the party responding to the service request for participation in at least a part of the resulting communication costs.

11. System according to claim 1, characterized in that the connection establishment and control functionality includes as a sub-functionality a VPN implementation.

12. System according to claims 1, characterized in that the server environment includes a functionality for creating about the information to be provided by it.

13. System according to claims 1, characterized in that when the terminal device of the party responding to the service request is in a state out of reach, the connection is diverted to an identifier established by the party responding to the service request, which identifier is, for example, a remote server arranged in connection with the data transfer network, for which e.g. contents and user data are synchronized from the server terminal device.

14. System according to claim 13, characterized in that data established in advance by the party responding to the service request is downloaded from the said remote server in the terminal device of the party making the service request.

15. System according to claim 13, characterized in that in connection with the remote servers have by servents synchronized content/application index information of the server terminal devices, for example, in order to implement searching and networking services.
